(19) United States
(12) Patent Application Publication
(10) Pub. No.: US 2019/0155228 A1
(43) Pub. Date: May 23, 2019

(54) DYNAMIC FEATURE EXTRACTION AND REAL-TIME MODEL TUNING

(71) Applicant: General Electric Company, Schenectady, NY (US)

(72) Inventors: Veera Kishore Reddipalli, San Ramon, CA (US); Vamshi Gandrapu, San Ramon, CA (US)

(21) Appl. No.: 15/819,097

(22) Filed: Nov. 21, 2017

(51) Int. Cl. G05B 13/04; G05B 13/02

(52) U.S. Cl. CPC G05B 13/04; G05B 13/0265

(57) ABSTRACT

An original model is stored in a data storage device. The original model describes or represents the operation of an industrial machine. A stream of data is received from the industrial machine at a control circuit. At the control circuit, the streaming data is mapped to the original model of the industrial machine. Features or labels in the stream of data related to the industrial machine are determined, and a predetermined event in the stream of data that is related to the features or labels is detected. Upon detection of the occurrence of the predetermined event, a modified or fitted model is derived, and predictions about performance of the industrial machine are derived utilizing the modified or fitted model.

### BACKGROUND OF THE INVENTION

### Field of the Invention

The subject matter disclosed herein generally relates to models used to represent the behavior and performance of industrial machines, and, more specifically, to being able to adjust and fine-tune these models.

### Brief Description of the Related Art

Industrial equipment or assets, generally, are engineered to perform particular tasks as part of a business process. For example, industrial assets can include, among other things and without limitation, manufacturing equipment on a production line, wind turbines that generate electricity on a wind farm, healthcare or imaging devices (e.g., X-ray or MRI systems) for use in patient care facilities, or drilling equipment for use in mining operations. Other types of industrial assets may include vehicles such as fleets of trucks. The design and implementation of these assets often takes into account both the physics of the task at hand, as well as the environment in which such assets are configured to operate.

Various types of models have been developed to represent the behavior and performance of these machines. Inputs can be applied to a model and the results utilized to, among other things, make predictions as to the future behavior or performance of the machines. For instance, predictions can be made as to whether the machine will fail or otherwise become inoperative in the future. Predictions can also be made as to the efficiency and other performance characteristics of the machine.

### BRIEF DESCRIPTION OF THE INVENTION

Given an ordinality of 1 through n stream(s) of data, this invention applies machine learning techniques via a smart transformation to map the incoming data streams to a defined industrial semantic model, resolving the data streams into 1 . . . n number of features and labels extraction for further machine learning. The features and labels extracted are used to apply available analytics to derive a fitted (or updated) machine learning model. The fitted model can be used to perform forecasting and predictions resulting into valuable business outcomes in real time.

In many of these embodiments, a model is stored in a data storage device. The model describes or represents the operation of an industrial machine. A stream of data is received from the industrial machine at a control circuit. At the control circuit, the streaming data is mapped to the model of the industrial machine. Features or labels in the stream of data related to the industrial machine are determined, and a predetermined event in the stream of data that is related to the features or labels is detected. Upon detection of the occurrence of the predetermined event, a modified or fitted model is derived, and predictions about performance of the industrial machine are derived utilizing the modified or fitted model.

In aspects, the predetermined event is a random event that does not occur regularly over time. In examples, the features or labels relate to a physical operating parameter of the industrial machine. For instance, the physical parameter may be a temperature, pressure, speed, or acceleration. In other examples, the types of event stream include OT (operational technology) data coming from Industrial IOT devices through sensors, or IT (information technology) data coming from other IT systems like ERPs, Alerts and Cases and so forth.

In some examples, the control circuit utilizes analytics to derive the modified model. In other examples, the model comprises one or more mathematical equations. In other aspects, the modified model is a fitted machine learning model.

In others of these embodiments, a system of tuning a model that describes behavior of an industrial machine includes a data storage device, a transceiver circuit, and a control circuit.

The data storage device is configured to store a model that describes the operation of an industrial machine. The transceiver circuit receives a stream of data from the industrial machine.

The control circuit is coupled to the data storage device and the transceiver circuit and is configured to map the streaming data to the model of the industrial machine, determine features or labels in the stream of data related to the industrial machine. detect a predetermined event in the stream of data that is related to the features or labels, upon detection of the occurrence of the predetermined event, derive a modified model, and derive predictions about performance of the industrial machine utilizing the modified model.

### BRIEF DESCRIPTION OF THE DRAWINGS

For a more complete understanding of the disclosure, reference should be made to the following detailed description and accompanying drawings wherein:

FIG. 1 comprises a block diagram of a system that updates a model based upon the detection of random events according to various embodiments of the present invention;

FIG. 2 comprises a block diagram of a system that hat updates a model based upon the detection of random events according to various embodiments of the present invention;

FIG. 3 comprises a flow chart of an approach that updates a model based upon the detection of random events according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the present approaches, a model (used to make various types of predictions for an industrial environment) is updated (re-trained or fitted) in real-time based upon or triggered by random events that are detected in a stream of incoming data. The stream of events can be in the form of OT/IT data.

In aspects, a software engine on the cloud receives continuous, real time data. Events are present in the data, and the engine detects these events. Once an event is detected, changes to the model are made. In other words, the model is tuned in real-time as events occur. The events themselves serve as the trigger for model updates.

To take one example of an application of these approaches, weather data may impact the performance of a solar array. The engine may make predictions about the performance of the solar array based upon the data, e.g., how much energy is going to be produced. To make these predictions, a model of solar array is utilized. The model, in examples, may be one or more equations. Given a set of inputs, a prediction of future performance of the solar array can be made.

A current version of the model does not account for rainy weather and would predict X megawatts of energy in the afternoon. However, in the approaches of this invention a rain event may be detected and used to immediately trigger a change to the model that accounts for the rainy weather. Thus, the updated or fitted model would predict Y megawatts of energy as being produced by the solar array, which accounts for the rainy weather. It can be seen that more accurate predictions are possible using this invention.

Advantageously, the present approaches provide model re-training that is triggered by random events in a data stream. The events made be of a known type (e.g., rainfall), but the occurrence of these events is random (e.g., the event can occur any time). This means models are updated as needed.

While some machine learning models focus on the identification of the patterns in the data and resolving them into a finite set of useful dimensions (e.g., according to feature vectors), which can be used to train a model and later used to perform predictions or forecasting against these features, in aspects, this invention utilizes software to apply dynamic pattern recognition and transformations approaches to incoming data that is used to modify models. For example, if a model is trained against time dimension data (time series data, waveforms, etc.), the invention will enable dynamic retraining and tuning of a model when a new kind of data is associated (e.g., spectrum data, which is in the frequency dimension). The invention utilizes intelligent “pipelines” of machine learning, with smart extractors and transforms, which because of pattern recognition approaches, can derive spectrum information from waveforms by intelligently applying applicable transformation algorithms. In examples, certain patterns in data represent certain features.

For example, consider a machine learning “pipeline” software element that predicts peak power output from a solar farm on a particular day in the future considering specific operating conditions such as weather conditions. A model that models or describes behavior of the solar farm can be further dynamically tuned with additional data as the data arrives in real-time (e.g., data concerning a sand storm as shown by solar spectrum data). The present approaches recognize the new data inputs (in this case, new solar spectrum data), and applies a suitable transformation algorithm to transform the frequency domain solar spectrum data to time dimension data (such as time series or waveforms), thereby providing better accuracy in predictions. It will be appreciated that the present approaches are not limited to specific use cases, but providing the intelligence to re-training and tuning of machine learning pipelines. The occurrence of the event ensures that the updated model will better represent the asset in the future even after the event occurs. In other words, the predictions made by the updated model are different from the original model, even during future conditions that exactly match the operating conditions of the originally deployed model.

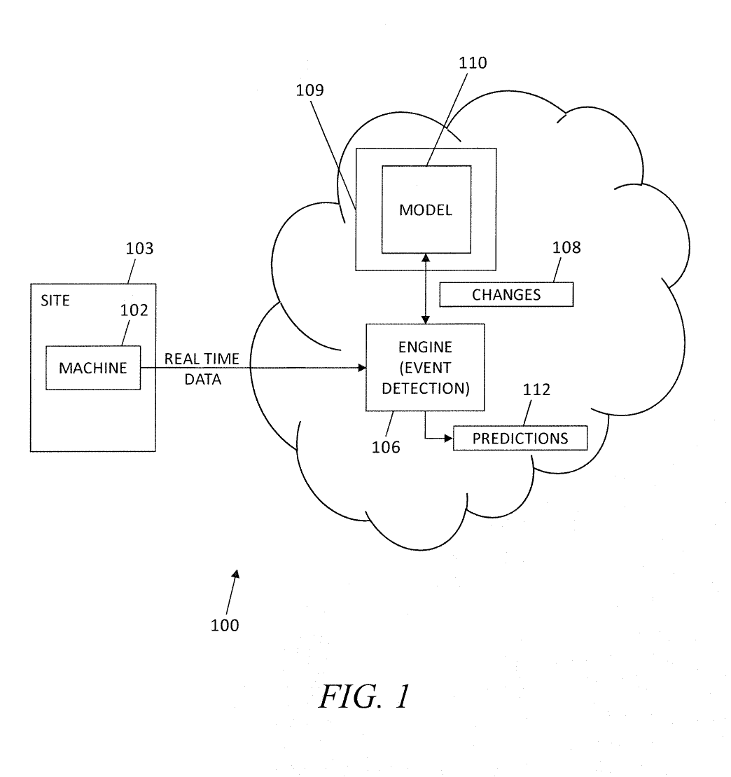

Referring now to FIG. 1, one example of a system 100 that updates a model is described. The system 100 includes an industrial machine or asset 102 at a site 103 that supplies data to the cloud (or other type of network or combination of networks) 104. At the cloud 104 is disposed an engine 106. The engine 106 receives the data and issues changes 108 to a model 110. The updated or fitted model 110 is used to make predictions 112 concerning the future performance of the machine 102.

The machine or asset 102 may be any type of industrial machine such as manufacturing equipment on a production line, wind turbines that generate electricity on a wind farm, healthcare or imaging devices (e.g., X-ray or MRI systems) for use in patient care facilities, or drilling equipment for use in mining operations. Other types of industrial assets may include vehicles such as fleets of trucks. Other examples of industrial machines are possible. Although a single industrial machine is shown in FIG. 1, it will be appreciated that multiple industrial machines may be utilized.

The site 103 may be any type of site such as a power plant, a wind farm, an industrial plant, a school, or a business. Other examples of sites are possible.

The engine 106 may be implemented as computer software instructions that are executed at a processing device or control circuit. The model 108 may be stored in a memory storage device 109. The memory storage device 109 is any type of memory that stores information. The model 108 may be represented as one or more equations, algorithms, subroutines, procedures, or combinations of these or other elements. In one specific example, the model 108 is a set of equations that are stored in the memory storage device 109. The model 108 describes the performance and operation of the machine.

The engine 106 and model may be part of or interface with the Predix™ platform as supplied by General Electric. In an example, the industrial machine or asset 102 can be outfitted with one or more sensors configured to monitor respective ones of an asset's operations or conditions. Data from the one or more sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, or to enhanced software algorithms for operating the same or similar asset at its edge, that is, at the extremes of its expected or available operating conditions.

The systems and methods for managing industrial assets can include or can be a portion of an Industrial Internet of Things (IIoT). In an example, an IIoT connects industrial assets, such as turbines, jet engines, and locomotives, to the Internet or cloud, or to each other in some meaningful way. The systems and methods described herein can include using a “cloud” or remote or distributed computing resource or service. The cloud can be used to receive, relay, transmit, store, analyze, or otherwise process information for or about one or more industrial assets. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

However, the integration of industrial assets with the remote computing resources to enable the IIoT often presents technical challenges separate and distinct from the specific industry and from computer networks, generally. A given industrial asset may need to be configured with novel interfaces and communication protocols to send and receive data to and from distributed computing resources. Given industrial assets may have strict requirements for cost, weight, security, performance, signal interference, and the like such that enabling such an interface is rarely as simple as combining the industrial asset with a general purpose computing device.

To address these problems and other problems resulting from the intersection of certain industrial fields and the IIoT, embodiments may enable improved interfaces, techniques, protocols, and algorithms for facilitating communication with and configuration of industrial assets via remote computing platforms and frameworks. Improvements in this regard may relate to both improvements that address particular challenges related to particular industrial assets (e.g., improved aircraft engines, wind turbines, locomotives, medical imaging equipment) that address particular problems related to use of these industrial assets with these remote computing platforms and frameworks, and also improvements that address challenges related to operation of the platform itself to provide improved mechanisms for configuration, analytics, and remote management of industrial assets.

The Predix™ platform available from GE is a novel embodiment of such Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial assets can be uniquely situated to leverage its understanding of industrial assets themselves, models of such assets, and industrial operations or applications of such assets, to create new value for industrial customers through asset insights.

Events or patterns representing events are present in the data, and the engine detects these events. For example, the data (e.g., temperature, humidity, windspeed, or cloud cover) may be indicative of weather events (e.g., rainy weather, sunny weather, snowfall, or windy weather). The engine 106 may be programmed to determine patterns within the data. For example, if the humidity is low, no precipitation is occurring, and there is not a detection of clouds in the sky, then sunny weather may be determined to exist.

Once an event is detected, changes to the model 108 are made. In other words, the model is tuned in real-time as events occur. The occurrence of the events themselves serve as the trigger for model updates. For example, if the model is represented by one or more mathematical equations, these equations can be modified, new equations added, or existing equations deleted to account for the event that was detected. In other words, the events can occur randomly, and the model is tuned according to these events. This may result in the model of an asset that has been running being meaningfully different than a model of an asset that has not been running. By being subject to the various actual, operational occurrences that determine the operating history and environment of the asset, the model of the particular asset will more reliably reflect, and therefore predict, the operation of the asset.

To take one example of the application of these approaches, the industrial machine 102 may be a solar array. Weather data may be obtained by various types of sensors and sent to the cloud 104. The engine 106 at the cloud 104 receives the data and may make predictions based upon the data, e.g., how much energy is going to be produced by the industrial machine 102.

A current version of the model 110 does not account for rainy weather and would predict X megawatts of energy being produced by the solar array in the afternoon. However, in the approaches of this invention a rain event may be detected in the data and used to immediately trigger changes 108 to the model 110 that accounts for the rainy weather. In one example, the model 110 is a set of equations. The changes 108 may modify existing equations, add new equations, or delete existing equations to mention a few examples. The changes 108 are triggered by the detection of a rainy event in the data. After the changes 108 are applied to the model 110, the model 110 takes into account the possibility of the occurrence of rainy weather, while before the changes 108 were applied, the model 110 did not consider the possibility of rainy weather.

Thus, the updated or fitted model 110 would be used by the engine 106 to predict Y megawatts of energy as being produced, which accounts for the rainy weather. It can be seen that more accurate predictions are possible using this invention. The occurrence of the event ensures that the updated model will better represent the asset in the future even after the event occurs. In other words, the predictions made by the updated model are different from the original model, even during future conditions that exactly match the operating conditions of the originally deployed model.

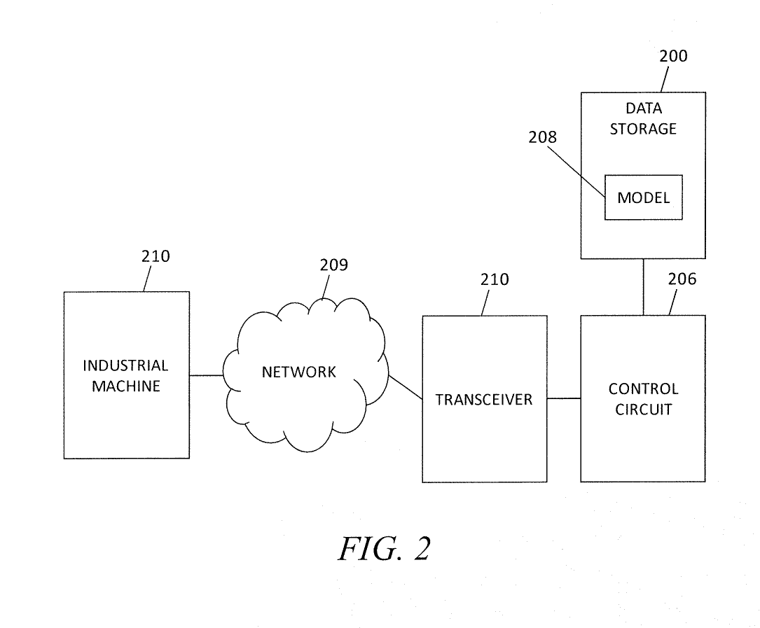

Referring now to FIG. 2, an example of another system 200 used to change a model is described. The system 200 includes a data storage device 202, a transceiver circuit 204, and a control circuit 206.

The data storage device 202 is configured to store a model 208 of an industrial machine or asset that describes the operation of an industrial machine 210. In example, the model 208 may be an equation or set of equations. Other examples of models are possible.

The transceiver circuit 204 receives a stream of data from the industrial machine 210 via a network 209. In examples, the transceiver circuit 204 is any combination of hardware (and/or software) that receives, formats, and/or buffers data received from an industrial machine.

The control circuit 206 is coupled to the data storage device and the transceiver circuit. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 206 may be configured (for example, by using corresponding programming stored in a memory as will be well understood by those skilled in the art) to carry out one or more of the steps, actions, and/or functions described herein.

The control circuit 206 is configured to map the streaming data to the model 208 of the industrial machine. For example, the data storage device 202 may include models of multiple industrial machines and the control circuit 206 maps the data to the correct model. For example, certain weather data may map to a first model of a solar array. Other weather data may map to a model of a windmill. The data itself may indicate (or include some) separate indication of the model(s), or the type of data itself may indicate the model. Various algorithms, e.g., implemented as programmed computer instructions executed by a processing device or control circuit, may determine which model is to be used.

The control circuit 206 is configured to determine features or labels in the stream of data related to the industrial machine. The features or labels may relate to a physical operating parameter of the industrial machine such as a temperature, pressure, speed, or acceleration.

The control circuit 206 is configured to detect a predetermined event in the stream of data that is related to the features or labels. For example, certain combination of parameters may indicate or map to a particular event. For instance, certain sensed humidity, temperature, and barometric pressure ranges (features or labels) may map to various types of weather conditions (events such as a rain event).

The control circuit 206 is configured to, upon detection of the occurrence of the predetermined event, derive a modified model. In examples, the model may be a set of equations. The set of equations may be modified to account for the event. For instance, equation parameters (e.g., constants or coefficients) may be changed to reflect the detected event.

The control circuit 206 is configured to derive predictions about performance of the industrial machine utilizing the modified model. For instance and when the model is a set of equations, inputs are applied to the equations to derive predictions.

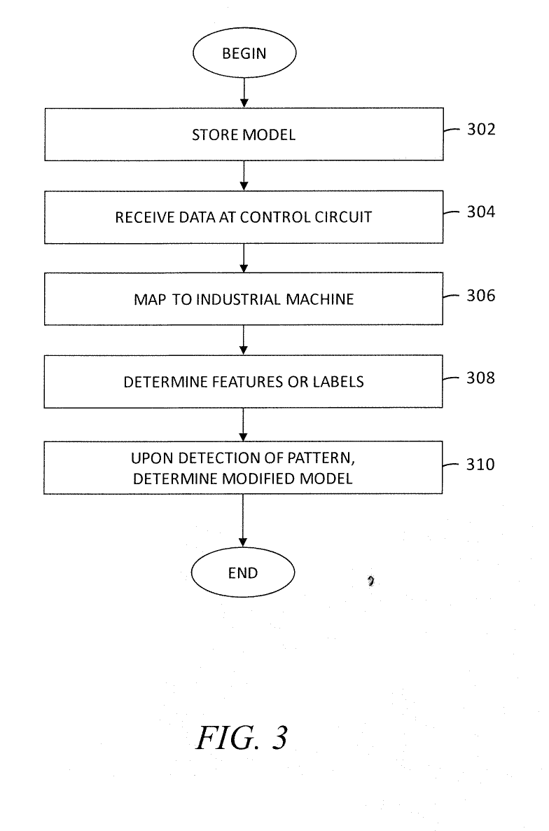

Referring now to FIG. 3, one example of an approach that changes a model is described. At step 302, a model is stored in a data storage device. The model describes or represents the operation of an industrial machine.

At step 304, a stream of data is received from the industrial machine at a control circuit. In examples, the stream of data includes time series data such as pressure, temperature, or speed data. Other examples are possible. This data may be obtained by various sensors. For example, sensors may be deployed at or near the industrial machine or asset to obtain the data.

At step 306 and at the control circuit, the streaming data is mapped to the model of the industrial machine. In aspects, various models may be stored in memory and represent various machines or assets. The data may be mapped in a variety of different ways. For example, certain models may utilize different types of data. To take one specific example, a model of a solar array may utilize temperature, humidity, and wind data. This data may be automatically mapped to the model of the solar array.

At step 308, features or labels in the stream of data related to the industrial machine are determined, and a predetermined event in the stream of data that is related to the features or labels is detected. In aspects, the predetermined event is a random event that does not occur regularly over time. In examples, the features or labels relate to a physical operating parameter of the industrial machine. For instance, the physical parameter may be a temperature, pressure, speed, or acceleration. Other examples are possible. Pattern recognition approaches can recognize features of labels. In addition, a suitable transformation algorithm may be applied to transform data from one form to another (e.g., from the frequency domain to a time dimension such as time series data or time waveforms), thereby further improving the accuracy of predictions.

At step 310, upon detection of the occurrence of the predetermined event, a modified or fitted model is derived, and predictions about performance of the industrial machine are derived utilizing the modified or fitted model. In some examples, the control circuit utilizes analytics to derive the modified model. As mentioned, the occurrence of the event ensures that the updated model will better represent the asset in the future even after the event occurs. In other words, the predictions made by the updated model are different from the original model, even during future conditions that exactly match the operating conditions of the originally deployed model.

In other examples, the model comprises one or more mathematical equations. The equations or portions of the equations may be modified to obtain the updated model. In other aspects, the modified model is a fitted machine learning model.

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method for tuning a model that describes behavior of an industrial machine, the method comprising:
storing an original model in a data storage device, the original model describing the operation of an industrial machine;
receiving a stream of data from the industrial machine at a control circuit;
at the control circuit:
mapping the streaming data to the model of the industrial machine;
determining features or labels in the stream of data related to the industrial machine;
detecting a predetermined event in the stream of data that is related to the features or labels;
upon detection of the occurrence of the predetermined event, deriving a modified model from the original model; and
deriving predictions about performance of the industrial machine utilizing the modified model.

2. The method of claim 1, wherein the predetermined event is a random event.

3. The method of claim 1, wherein the features or labels relate to a physical operating parameter of the industrial machine.

4. The method of claim 3, wherein the physical parameter is a temperature, pressure, speed, or acceleration.

5. The method of claim 1, wherein the control circuit utilizes analytics to derive the modified model.

6. The method of claim 1, wherein the model comprises one or more mathematical equations.

7. The method of claim 1, wherein the modified model is a fitted machine learning model.

8. The method of claim 1, wherein the predictions of the modified model are different than predictions of the original model even when subjected to same conditions that were used in creating the original model.

9. The method of claim 1, wherein the original model is updated in real-time.

10. A system of tuning a model that describes behavior of an industrial machine, the system comprising:
a data storage device that is configured to store an original model that describes the operation of an industrial machine;
a transceiver circuit that receives a stream of data from the industrial machine;
a control circuit that is coupled to the data storage device and the transceiver circuit, the control circuit being configured to:
map the streaming data to the original model of the industrial machine;
determine features or labels in the stream of data related to the industrial machine;
detect a predetermined event in the stream of data that is related to the features or labels;
upon detection of the occurrence of the predetermined event, derive a modified model from the original model;
derive predictions about performance of the industrial machine utilizing the modified model.

11. The system of claim 10, wherein the predetermined event is a random event.

12. The system of claim 10, wherein the features or labels relate to a physical operating parameter of the industrial machine.

13. The system of claim 12, wherein the physical parameter is a temperature, pressure, speed, or acceleration.

14. The system of claim 10, wherein the control circuit utilizes analytics to derive the modified model.

15. The system of claim 10, wherein the model comprises one or more mathematical equations.

16. The system of claim 10, wherein the modified model is a fitted machine learning model.

17. The system of claim 10, wherein the predictions of the modified model are different than predictions of the original model even when subjected to same conditions that were used in creating the original model.

18. The system of claim 10, wherein the original model is updated in real-time.
